(19) United States
(12) Patent Application Publication
(10) Pub. No.: US 2007/0154814 A1
(43) Pub. Date: Jul. 5, 2007

(54) Nas battery using liquid electrolyte

(76) Inventors: Dong-Hyun Ryu, Yeosu-si (KR); Chul-Wan Park, Masan-si (KR); Hyo-Jun Ahn, Jinju-si (KR); Bong-Jun Kim, Jinhae-si (KR); Eun-Mi Lee, Jinju-si (KR); Ho-Suk Ryu, Jinju-si (KR); Sang-Won Lee, Masan-si (KR); Ki-Won Kim, Jinju-si (KR); Jou-Hyeon Ahn, Jinju-si (KR); Jai-Young Lee, Daejeon (KR); Sang-Sik Jeong, Jinju-si (KR); Byung-Su Jung, Gyeongsangnam-do (KR); Duck-Jun Lee, Jinhae-si (KR); Young-Jin Choi, Changwon-si (KR); Jin-Kyu Kim, Jinju-si (KR)

Correspondence Address: MATHEWS, SHEPHERD, MCKAY, & BRUNEAU, P.A., 29 THANET ROAD, SUITE 201, PRINCETON, NJ, 08540, US

(21) Appl. No.: 10/586,931

(22) PCT Filed: Mar. 3, 2004
(86) PCT No.: PCT/KR04/00454

§ 371 Date: Jul. 21, 2006

(30) Foreign Application Priority Data
Feb. 17, 2004 (KR) 10-2004-0010473

(51) Int. Cl. H01M 6/18

(52) U.S. Cl. 429/321

(57) ABSTRACT

The present invention relates to a sodium-sulfur battery consisted of solid sodium for the negative electrode (comprising carbon, sodium metal oxide and the like comprising sodium compound, sodium ion); solid sulfur for the positive electrode (comprising sulfur, sulfur compound such as iron sulfide, nickel sulfide); and liquid electrolyte which sodium salt and organic solvent such as grymids or carbonates are soaked in cell guard, thereby improving a drawback of prior art for conventional battery.

### TECHNICAL FIELD

The present invention relates to a sodium-sulfur battery having a improved pattern, more precisely a sodium-sulfur battery consisted of solid sodium for the negative electrode (comprising carbon, sodium metal oxide and the like comprising sodium compound, sodium ion); solid sulfur for the positive electrode (comprising sulfur, sulfur compound such as iron sulfide, nickel sulfide); and liquid electrolyte which sodium salt and organic solvent such as grymids or carbonates are soaked in cell guard.

### BACKGROUND ART

Sodium is in the spotlights as a material for the negative electrode because it has a standard reduction potential of −2.71V and then, using this property, it is possible to obtain cell voltage of the above 2V. Furthermore, sodium is comprised in the earth's crust an amount of average value of 2.63%, therefore it is abundant element, its price is very low such as about $47/ton (USA). Sulfur is also abundant element, therefore its cost is inexpensive. Particularly, it is much more economical than a conventional lithium/sulfur battery because it use sodium instead of lithium, an expensive material.

In 1967, the Ford co. had invented a sodium beta alumina electrolyte having high conductivity of sodium ion and carried out continuously further research and filed application for patent. However, to keep up high conductivity of sodium ion, it must be maintained high temperature of above 300° C. Therefore, sodium for the negative electrode and sulfur for the positive electrode are presented as liquid phase at 300° C., as result, it is very reactive and explosive. Therefore, a conventional lithium/sulfur battery has many problems such as corrosiveness of cell, adhesive property of cell and stability and the like because it was constructed as the above.

To solve a problem of a conventional high temperature type liquid sodium/ceramic electrolyte/liquid sulfur battery, it is filed and registered for the sodium/sulfur battery which a high molecule electrolyte of solid phase is used as an electrolyte instead of a conventional ceramic electrolyte and a liquid negative and positive electrode are replaced by a solid phase (Korea patent registration No. 0402109). However, although it has the merit that a liquid electrolyte is an organic solvent having a high ion conductivity at normal temperature and it is simple to prepare and use, it has also the drawback that an ion conductivity of a high molecule electrolyte of solid phase is very low, a preparing procedure is complex and its cost is expensive. Therefore, there is not reported any research for which a liquid electrode is adapted to a sodium/sulfur battery. Furthermore, there is also not reported any research for an improved sodium/sulfur battery being capable of replacing sodium metal or sulfur.

### DISCLOSURE OF THE INVENTION

It is an object of the invention to provide a liquid electrolyte suitable for a sodium/sulfur battery and being capable of replacing a conventional solid high molecule electrolyte, and solid sodium for the negative electrode and solid sulfur for the positive electrode being capable of replacing liquid sodium for the negative electrode and liquid sulfur for the positive electrode, thereby providing the sodium/sulfur battery being capable of operating at normal temperature in a solid state. Particularly, by using the above-described liquid electrolyte, solid sodium for the negative electrode and solid sulfur for the positive electrode, it is possible to solve the problem for stability and limited operating temperature knowing as a drawback of a conventional sodium/sulfur battery and to improve a drawback of a conventional battery.

It is another object of the invention to provide the electrode (for example, carbon or sodium-carbon compound being capable of replacing sodium, metal sulfide such as iron sulfide, nickel sulfide etc. being capable of replacing sulfur) that is more stable at normal temperature than sodium or sulfur, and charge and discharge property is improved.

The above-mentioned object of the present invention can be achieved by preparing a sodium/sulfur battery consisted of sodium of solid phase for the negative electrode, sulfur of solid phase for the positive electrode, and liquid electrolyte which sodium salt and organic solvent are soaked in cell guard; or a sodium/sulfur battery consisted of carbon for the negative electrode containing sodium ion of solid phase, sulfur of solid phase for the positive electrode, and liquid electrolyte which sodium salt and organic solvent are soaked in cell guard; or a sodium/sulfur battery consisted of sodium of solid phase for the negative electrode, nickel sulfide of solid phase for the positive electrode, and liquid electrolyte which sodium salt and organic solvent are soaked in cell guard; or a sodium/sulfur battery consisted of sodium of solid phase for the negative electrode, iron sulfide of solid phase for the positive electrode, and liquid electrolyte which sodium salt and organic solvent are soaked in cell guard; and by confirming the fact that the above battery operate at normal temperature and represent an excellent charge and discharge property through an experiment.

### DESCRIPTION OF DRAWINGS

Other objects and aspects of the present invention will become apparent from the following description of embodiments with reference to the accompanying drawing in which:

FIG. 1 is the graph that represent discharge curve of a sodium/sulfur battery being consisted of sodium of solid phase and 70 wt % sulfur electrode according to the present invention.

FIG. 2 is the graph that represent discharge curve of a sodium/sulfur battery being consisted of sodium of solid phase and 50 wt % sulfur electrode according to the present invention.

FIG. 3 is the graph that represent discharge curve of a sodium/sulfur battery being consisted of sodium of solid phase and sulfur electrode according to the present invention, having one flatten voltage section for discharge.

FIG. 4 is the graph representing cycle property of a sodium/sulfur battery being consisted of sodium of solid phase and sulfur electrode according to the present invention.

FIG. 5 is the graph representing charge and discharge property of a sodium ion for carbon electrode according to the present invention.

FIG. 6 is the graph that represent discharge curve of a sodium/iron sulfide battery being consisted of sodium of solid phase and iron sulfide electrode according to the present invention.

FIG. 7 is the graph that represent discharge curve of a sodium/nickel sulfide battery being consisted of sodium of solid phase and nickel sulfide electrode according to the present invention.

FIG. 8 is the graph representing cycle property of a sodium/nickel sulfide battery being consisted of sodium of solid phase and nickel sulfide electrode according to the present invention.

### DETAILED DESCRIPTION OF THE PREFERRED EMBODIMENT

The above-described present invention relate to a sodium/sulfur battery of improved type which operate stably at normal temperature by improving a stability and a limitation for operating temperature of above 300° C., a drawback of a conventional sodium/sulfur battery, and can be prepared easily, and also represent an excellent charge and discharge property.

The sodium-sulfur battery according to the present invention is consisted of solid sodium for the negative electrode (comprising carbon, sodium metal oxide and the like comprising sodium compound, sodium ion); solid sulfur for the positive electrode (comprising sulfur, sulfur compound such as iron sulfide, nickel sulfide); and liquid electrolyte which sodium salt and organic solvent such as grymids or carbonates are soaked in cell guard.

The above liquid electrolyte of grymids is consisted of 0.1˜2.0 mol conc. of sodium salt in grymids solvent. The above liquid electrolyte of carbonates is also consisted of 0.1˜2.0 mol conc. of sodium salt in carbonates solvent. The above liquid electrolyte is used as electrolyte by socking it in cell guard functioning as a separate membrane.

The above solid sulfur for the positive electrode is consisted of 70 wt % of sulfur, 15 wt % of carbon and 15 wt % of polyethyleneoxide, or 50 wt % of sulfur, 30 wt % of carbon and 20 wt % of polyethyleneoxide. The above solid sulfur compound for the positive electrode is consisted of NiS powder or FeS₂ powder. The above sulfur can be selected from group consisting of active sulfur, organic sulfur, organic sulfur compound and alloy using sulfur.

The above solid sodium for the negative electrode can be selected from group consisting of sodium metal, sodium powder, sodium alloy, sodium compound, carbon comprising sodium ion and sodium metal oxide.

The above grymids solvent used in preparing liquid electrolyte can be selected from group consisting of monoethylene, diethylene, triethylene, tetraethylene, tetraethylene glycol dimethyl ether and polyethylene glycol dimethyl ether.

The above carbonates solvent used in preparing liquid electrolyte is a solvent having high permittivity constant value such as EC (ethylene carbonate), PC (propylene carbonate). They also have high conductivity, therefore it is expected to apply commercially.

The above sodium salt can be selected from group consisting of sodium nitrate, sodium trifluorometasulfonate, and sodium trimetasulfonate amide.

The sodium/sulfur battery prepared according to the present invention represent discharge capacity of above 650 mAh/g per active material of the positive electrode at normal temperature.

An agitator, a mixer, an ultrasonic generator and the like can be used to mix solvent with salt homogeneously to prepare the above liquid electrolyte.

When prepare the above liquid electrolyte, it can be mixed to mix solvent with salt by using an agitator. Especially, in the preparing procedure of electrolyte using an agitator comprising a electromagnet, a vessel and a magnetic bar, the above magnetic bar can be all shape that is able to abut with the above vessel properly, the above vessel can be shaped of trigonal flask or multi-side shape. Also, we can use a magnetic bar made of metal material such as stainless steel and iron.

The concrete embodiment of the present invention will be illustrated in detail by following example, but this is not to limit the scope of the present invention.

### EXAMPLE 1

### Preparing Procedure of Liquid Electrolyte for Sodium/Sulfur Battery

Two liquid electrolytes having different composition are each prepared.

First, sodium salt titrate concentration of 0.1˜2.0 mol using ethylene carbonate and propylene carbonate as solvent. And this mixture is agitated for 3 hr with an agitator to prepare a viscous liquid phase mixed homogeneously, and then this liquid electrolyte is soaked in cell guard to use as electrolytes. The above procedure is carried out in a glove box at atmosphere of argon.

As a separate procedure with the above procedure, sodium salt titrate concentration of 0.1˜2.0 mol using tetraethylene glycol dimethyl ether as solvent. And this mixture is agitated for 3 hr with an agitator to prepare a viscous liquid phase mixed homogeneously, and then this liquid electrolyte is soaked in cell guard to use as electrolytes. The above procedure is carried out in a glove box at atmosphere of argon.

### EXAMPLE 2

### Preparing Procedure of Sodium Electrode and Sulfur/Sulfur Compound Electrode

As the negative electrode, sodium metal is used as electrode, also as the positive electrode, sulfur or sulfur compound is used as electrode.

The sodium electrode is prepared by cutting a sodium lump in a glove box to thin circular shape having a thickness of below 1 mm.

The above sulfur electrode is prepared with two kinds, one is consisted of 70 wt % of sulfur, 15 wt % of carbon and 15 wt % of polyethyleneoxide, and the other is consisted of 50 wt % of sulfur, 30 wt % of carbon and 20 wt % of polyethyleneoxide. A sample of the above composition is titrated by using acetonitrile as solvent. At this time, weight rate of the above sample and solvent is 1:4. Polyethyleneoxide and acetonitrile are agitated for 24 hr with an agitator and then introduced to an atritor together with sulfur and carbon and mixed for 2 hr. After that, it is poured on a glass panel to cool and then dried in vacuum at 10-3 torr and 50° C. for 12 hr to obtain a sulfur electrode of film shape. The above procedure is carried out in general atmosphere.

The above sulfur compound electrode is prepared with nickel sulfide electrode and iron sulfide electrode. First, nickel sulfide electrode is prepared as following; a sample of 20 wt % of nickel and 80 wt % sulfur is titrated by using NMP as solvent. At this time, rate of solvent per the above sample is 1 cc/0.5 g. After agitation, it is poured on a aluminium foil to cool and then dried in vacuum at 10-3 torr and 50° C. for 12 hr to obtain a sulfur electrode of film shape. The above procedure is carried out in general atmosphere.

Next, iron sulfide electrode is prepared as following; a sample of 70 wt % of iron sulfide powder, 15 wt % of carbon and 15 wt % polyethyleneoxide is titrated by using acetonitrile as solvent. At this time, rate of the above sample and solvent is 1:4 wt %. Polyethyleneoxide and acetonitrile are agitated for 24 hr with an agitator and then introduced to an atritor together with iron sulfide and carbon and mixed for 2hr. After that, it is poured on a glass panel to cool and then dried in vacuum at 10-3 torr and 50° C. for 12 hr to obtain a iron sulfide electrode of film shape. The above procedure is carried out in general atmosphere.

### EXAMPLE 3

### Discharge Property of Sodium/Sulfur Battery

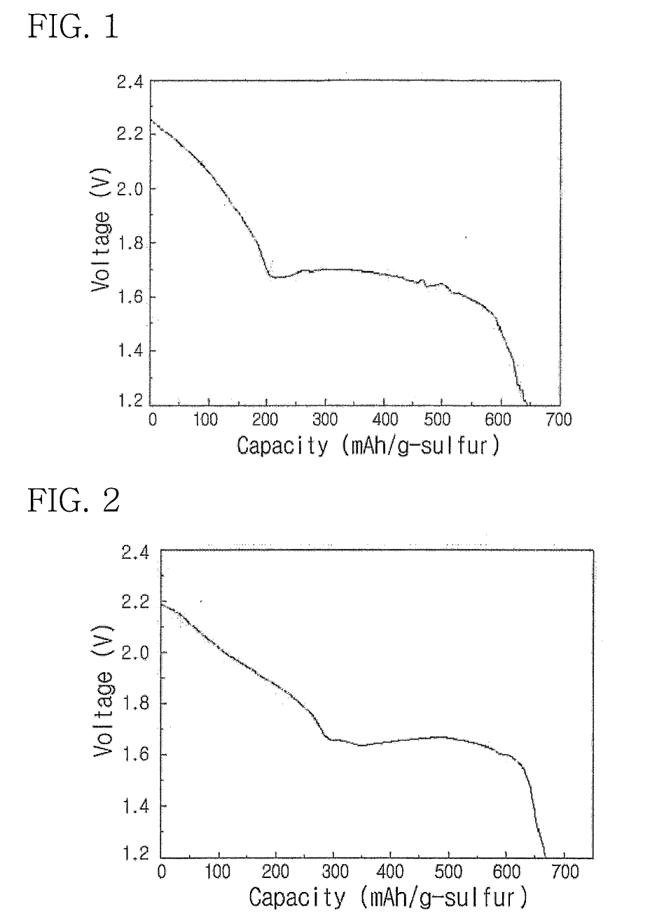

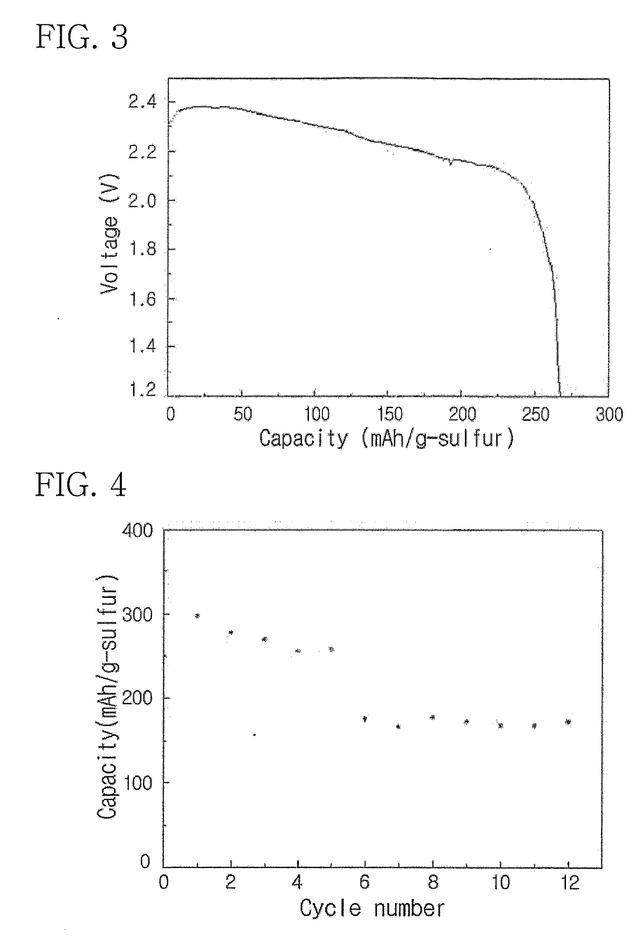

Under atmosphere of argon gas, a negative electrode, an electrolyte and a positive electrode are laminated in order to prepare sodium/sulfur battery. In this example, the above electrolyte is the electrolyte prepared at example 1, and a sodium electrode and a sulfur electrode are the electrode prepared at example 2. To test discharge property of sodium/sulfur battery, discharge capacity is measured by using a discharge tester. A condition for testing an electrode is as following; a dormancy time is maintained for 1 hour at normal temperature and then density of discharge current is controlled to 100 mA/g·sulfur, and terminal voltage is controlled to 1.2V. FIGS. 1 and 2 are the graph that represent discharge curve of a sodium/sulfur battery using the above liquid electrolyte of glymids, at normal temperature, it represent 648 mAh/g·sulfur of discharge capacity in case of 70 wt % of sulfur and 663 mAh/g·sulfur of discharge capacity in case of 50 wt % of sulfur. FIG. 3 is the graph that represent discharge curve of a sodium/sulfur battery using the above liquid electrolyte of carbonates, at normal temperature, it represent 269 mAh/g·sulfur of discharge capacity.

### EXAMPLE 4

### Preparing Procedure of Carbon Electrode Containing Sodium Ion and Discharge Property

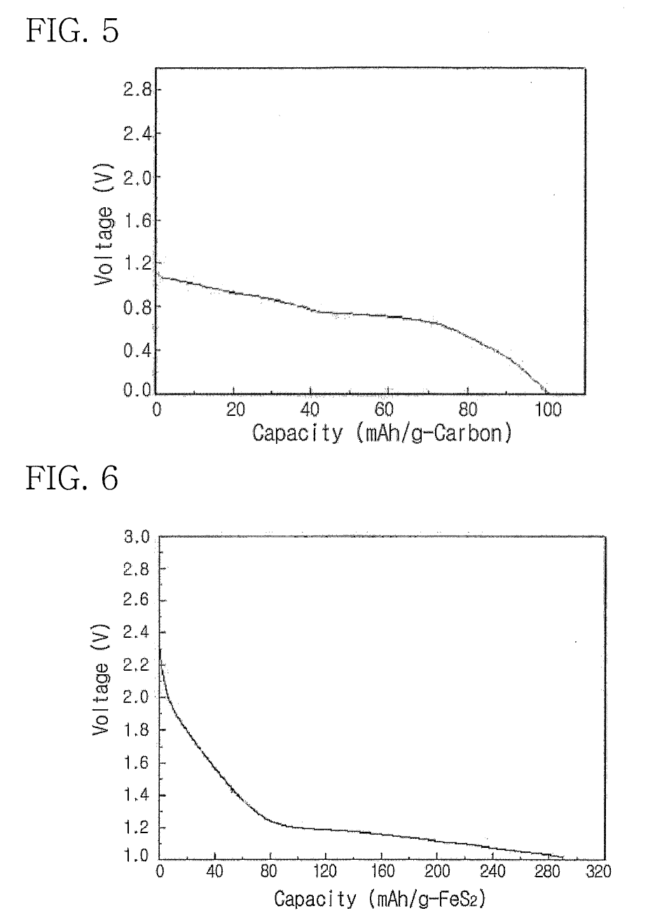

To survey possibility whether carbon electrode containing sodium ion can be used as a negative electrode or not, an insertion and secession reaction of sodium ion into carbon is carried out with electrochemical method. A carbon electrode is prepared as followings; a powder consisted of graphite:PVdF:carbon=8:1.5:0.5 is subjected attrition ball milling with dry type for 10 minutes and then it is mixed with NMP at rate of 2 cc per 0.5 g to prepare a slurry. And the above slurry is subjected to stir by stick and then it is cast on Cu foil (3×9.5 cm²) and then dried in vacuum. And then it is cut to square of 1×1 cm. A carbon electrode is prepared by using acetonitrile as solvent. At this time, rate of the above sample and solvent is 1:4 wt %. On the other hand, to add sodium to the above carbon, a sodium electrode is constructed with method as example 2. FIG. 5 is the graph representing an insertion reaction of sodium ion into carbon, using a liquid electrolyte of example 1, it represent 103 mAh/g·carbon of discharge capacity at normal temperature. The above method is carried out in a glove box.

### EXAMPLE 5

### Discharge Property of Sodium/Iron Sulfide Battery

Under atmosphere of argon gas, a negative electrode, an electrolyte and a positive electrode are laminated in order to prepare sodium/liquid electrolyte/iron sulfide battery. In this example, the above electrolyte is the electrolyte prepared at example 1, and a sodium electrode and an iron sulfide electrode are the electrode prepared at example 2. To test discharge property of sodium/iron sulfide battery, discharge capacity is measured by using a discharge tester. A condition for testing a grymides liquid electrode is as following; a dormancy time is maintained for 1 hour at normal temperature and then density of discharge current is controlled to 100 mA/g·sulfur, and terminal voltage is controlled to 0.9V. FIG. 6 is the graph that represent discharge curve of a sodium/iron sulfide battery using the above liquid electrolyte of grymides, at normal temperature, it represent 284 mAh/g·sulfur of discharge capacity.

### EXAMPLE 6

### Discharge Property of Sodium/Nickel Sulfide Battery

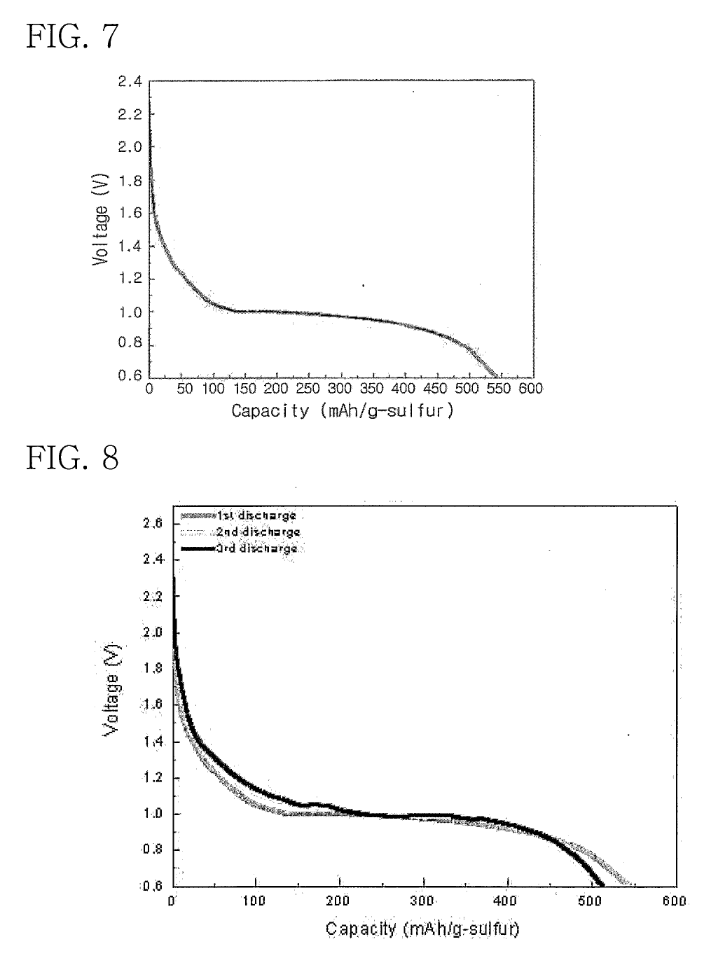

Under atmosphere of argon gas, a negative electrode, an electrolyte and a positive electrode are laminated in order to prepare sodium/liquid electrolyte/nickel sulfide battery. In this example, the above electrolyte is the electrolyte prepared at example 1, and a sodium electrode and an iron sulfide electrode are the electrode prepared at example 2. To test discharge property of sodium/nickel sulfide battery, discharge capacity is measured by using a discharge tester. A condition for testing a grymides liquid electrode is as following; a dormancy time is maintained for 1 hour at normal temperature and then density of discharge current is controlled to 100 mA/g·sulfur, and terminal voltage is controlled to 0V. FIG. 7 is the graph that represent discharge curve of a sodium/nickel sulfide battery using the above liquid electrolyte of grymides, at normal temperature, it represent 548 mAh/g·sulfur of discharge capacity.

### ADVANTAGEOUS EFFECTS

The above-described present invention provides a sodium/sulfur battery which solve a problem of a conventional sodium/ceramic electrolyte/sulfur battery such as a stability by leaking liquid phase, a corrosiveness of cell by reacted product, an adhesive property of cell and a limitation for operating temperature of above 300° C. of ceramic electrolyte and the like, by using a liquid electrolyte instead of an existing ceramic electrolyte (solid high molecule electrolyte) and replacing liquid phase for the negative electrode and liquid phase for the positive electrode to solid phase, and can operate stably at normal temperature, and have high price competitiveness due to law material of low cost, therefore the present invention is very useful in the industry.

1. A sodium/sulfur battery comprising solid sodium for the negative electrode; liquid electrolyte constituted by soaking grymids solvent or carbonates solvent including 0.1˜2.0 mol of sodium salt in cell guard; and solid sulfur for the positive electrode constituted with 10˜100 wt % of sulfur, 0.001˜50 wt % of carbon and 0.001˜50 wt % of polyethyleneoxide.

2. A sodium/sulfur battery of the above claim 1, wherein the above sodium of the negative electrode is selected from group consisting of sodium metal, sodium powder, sodium alloy, sodium compound, carbon comprising sodium ion and sodium metal oxide.

3. A sodium/sulfur battery of the above claim 1, wherein the above sulfur of the positive electrode is selected from group consisting of active sulfur, organic sulfur, organic sulfur compound and sulfur compound such as NiS, FeS₂ or PbS.

4. A sodium/sulfur battery of the above claim 1, wherein the above sodium salt is selected from group consisting of sodium nitrate, sodium trifluorometasulfonate, and sodium trimetasulfonate amide.

5. A sodium/sulfur battery of the above claim 1, wherein the above solvent among liquid electrolyte is selected from group consisting of monoethylene, diethylene, triethylene, tetraethylene, tetraethylene glycol dimethyl ether, polyethylene glycol dimethyl ether, ethylene carbonate, propylene carbonate.
